(19) United States
(12) Patent Application Publication
(10) Pub. No.: US 2013/0133473 A1
(43) Pub. Date: May 30, 2013

(54) PEDAL EFFORT ADJUSTING APPARATUS FOR ACCELERATOR PEDAL

(71) Applicants: Eun Sik Kim, Daegu (KR); Sung II Lee, Hwaseong-si (KR); Jeong Seon Min, Hwaseong-si (KR); Yang Rae Cho, Hwaseong-si (KR); Sun Geun Kim, Gyeongsan-si (KR)

(72) Inventors: Eun Sik Kim, Daegu (KR); Sung II Lee, Hwaseong-si (KR); Jeong Seon Min, Hwaseong-si (KR); Yang Rae Cho, Hwaseong-si (KR); Sun Geun Kim, Gyeongsan-si (KR)

(73) Assignees: Kia Motors Corp., Seoul (KR); Hyundai Motor Company, Seoul (KR)

(21) Appl. No.: 13/523,394

(22) Filed: Jun. 14, 2012

(30) Foreign Application Priority Data
Nov. 24, 2011 (KR) 10-2011-0123340

(51) Int. Cl. F16H 53/02

(52) U.S. Cl. 74/567

(57) ABSTRACT

A pedal effort adjusting apparatus of an acceleration pedal allows adjustment of the elastic force of an elastic member by moving a carrier with rotation of a rotary cam and to easily adjust a pedal effort of a pedal arm, if necessary.

### CROSS-REFERENCE TO RELATED APPLICATION

The present application claims priority of Korean Patent Application Number 10-2011-0123340 filed Nov. 24, 2011, the entire contents of which application is incorporated herein for all purposes by this reference.

### BACKGROUND OF INVENTION

1. Field of Invention

The present invention relates to a pedal effort adjusting apparatus of an accelerator pedal that can adjust a pedal effort of an accelerator pedal by simple operation of a user.

2. Description of Related Art

An acceleration pedal device of the related art includes, as shown in FIG. 1, a pedal arm housing 1 fixed to the dash panel under a driver seat, a pedal arm 2 having an end equipped with a pedal 2a and the other end inserted in the pedal arm 1 to be rotatable with respect to the pedal arm housing 1, a spring plate 3 coupled to the end of the pedal arm 2 disposed in the pedal arm housing 1, a friction shoe 4 coupled to the pedal arm 2 disposed in the pedal arm housing 1 and generate frictional interference with the inner wall of the pedal arm housing 1 when the pedal arm 2 rotates, and an elastic member 5 having one end supported by the spring plate 3 and the other end supported by the inner side, opposite the spring plate 3, of the pedal arm housing 1, in which the elastic member 5 is composed of an inner spring 5a and an outer spring 5b.

According to the acceleration pedal device, the sum of the reaction force of the friction shoe 4 generating frictional interference with the inner wall of the pedal arm housing 1 and the reaction force generated by the inner spring 5a and the outer spring 5b elastically compressed, when the pedal arm 2 rotates about a hinge shaft 2b, is a pedal effort that is applied to the pedal arm 2.

Since the larger the pedal effort, the more the force applied to the pedal arm 2 by a driver increases, the driver operating the acceleration pedal feels more tired, whereas when the pedal effort is small, the driver has difficulty in sufficiently felling the operation of the acceleration pedal, such that automobile manufacturers set the characteristics of a pedal effort in advance and manufactured acceleration pedals to follow the law of safety established by each country.

Therefore, the acceleration pedal device of the related art has a defect that it is necessary to replace the friction shoe 4 or the elastic member 5 with new one in order to adjust the pedal effort, such that the acceleration pedal device does not have compatibility.

The detailed configuration and operation of an exemplary acceleration pedal are described in detail in Korean Patent Registration No. 10-0724700.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a pedal effort adjusting apparatus of an acceleration pedal that can sufficiently satisfy the law of safety about a pedal effort and makes an acceleration pedal compatible, by making it possible to appropriately adjust a pedal effort of an acceleration pedal with a simple operation, if necessary, without replacing the parts.

Various aspects of the present invention provide for a pedal effort adjusting apparatus of an acceleration pedal includes: a rotary cam that is disposed in a carrier housing and has one end supported to be rotatable about the axis of the carrier housing; and a carrier that is disposed in the carrier housing, with the upper surface being in contact with the outer circumference of the rotary cam and the lower surface being in contact with one end of the elastic member providing a pedal effort to the pedal arm, and presses the elastic member or move to release the elastic member when the rotary cam rotates.

The carrier housing may be integrally formed with the pedal arm housing opposite the end of the pedal arm in the rotational direction of the pedal arm.

A camshaft may integrally protrude from one side of the rotary cam, and the camshaft rotates about an axis through a shaft hole formed at the carrier housing.

The rotary cam may have an outer circumference with a polygonal cross-section composed of a plurality of continuous planes.

A camshaft groove may be integrally formed inward circumferentially along the outer circumference of the camshaft, and the edge of the shaft hole is fitted in the camshaft groove.

When the points dividing the lengths of the planes into two parts, respectively, are middle positions, the distances of the straight lines connecting the middle positions of the planes to the rotational center of the rotary cam may be set different.

A tool insertion groove may be formed on one side of the cam shaft which protrudes outward from the carrier housing through the shaft hole, and the apparatus may further include a pedal effort adjusting tool that is inserted in the tool insertion groove to allow the rotary cam to rotate about the axis.

The pedal effort adjusting apparatus of an acceleration pedal allows adjustment of the elastic force of an elastic member by moving a carrier with rotation of a rotary cam and to easily adjust a pedal effort of a pedal arm, if necessary, such that it is possible to make the acceleration pedal compatible while sufficiently satisfying the law of safety about a pedal effort.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating an acceleration pedal device of the related art.

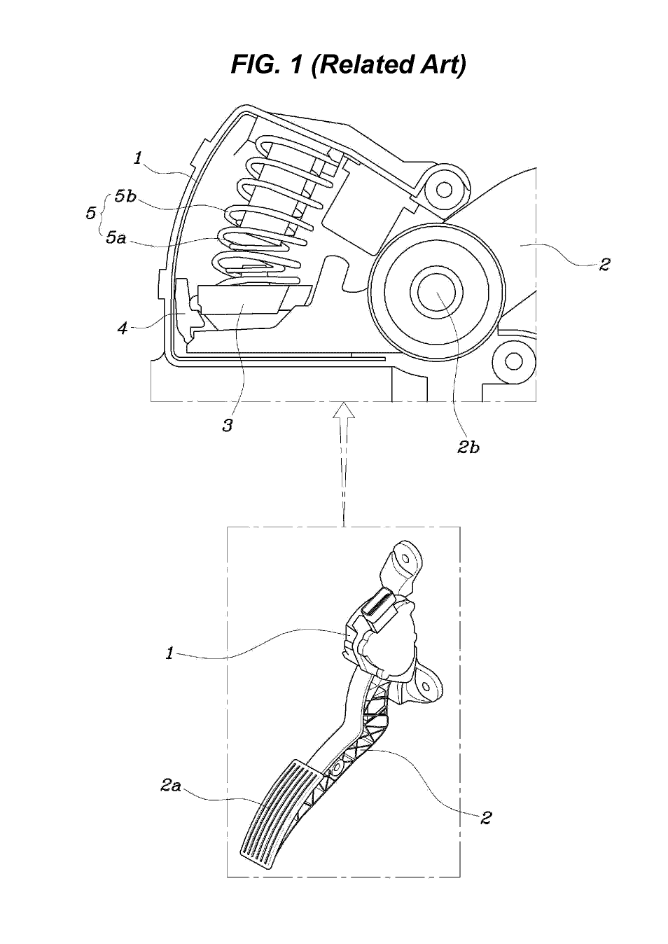

FIG. 2 is a view showing an exemplary acceleration pedal equipped with a pedal effort adjusting apparatus according to the present invention.

FIG. 3 is a view when a pedal arm housing cover is separated from FIG. 2.

FIG. 4 is a view when the pedal arm housing is removed from FIG. 3.

FIG. 5 is a cross-sectional view taken along the line I-I of FIG. 2.

FIG. 6 is a view illustrating an exemplary rotary cam according to the present invention.

It should be understood that the appended drawings are not necessarily to scale, presenting a somewhat simplified representation of various features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

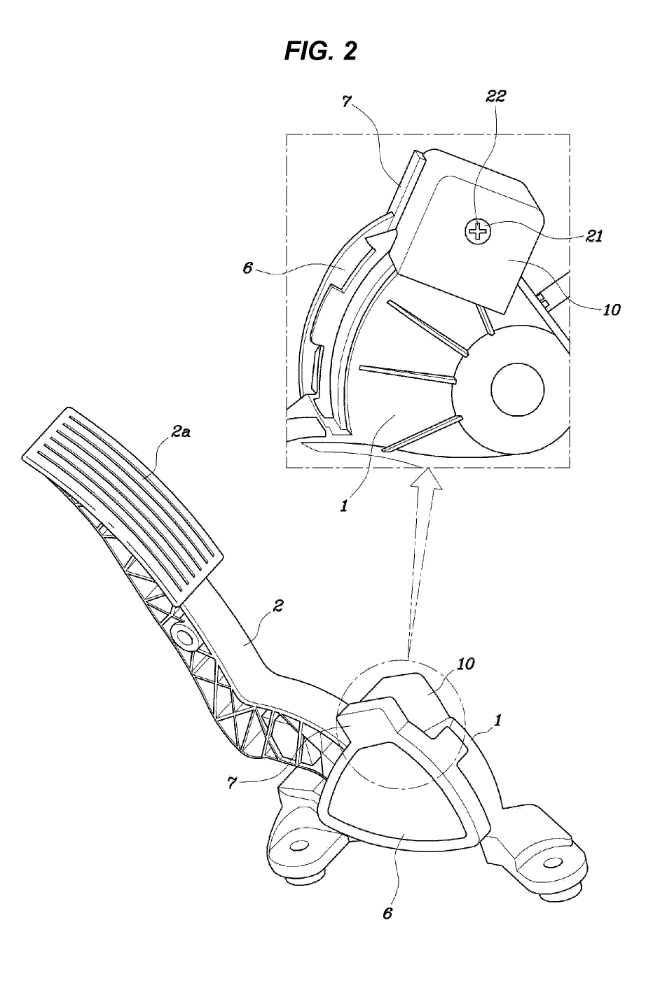

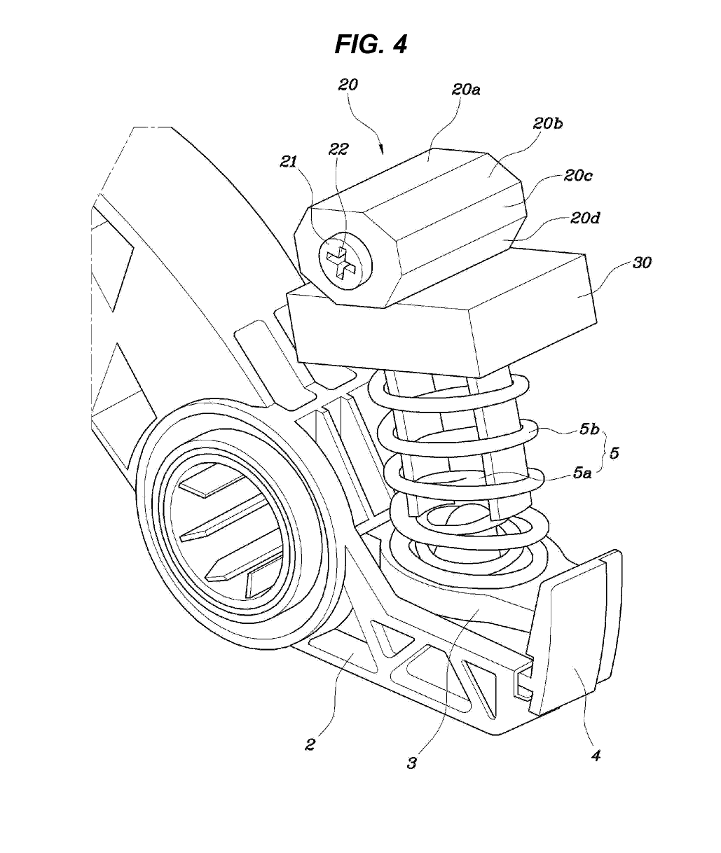

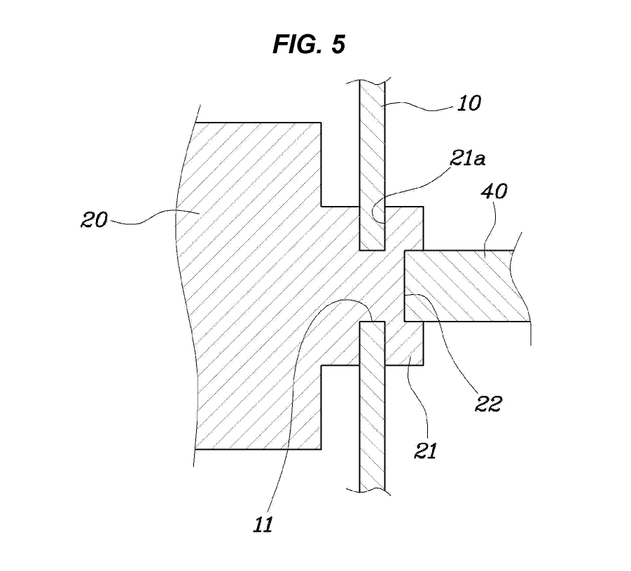

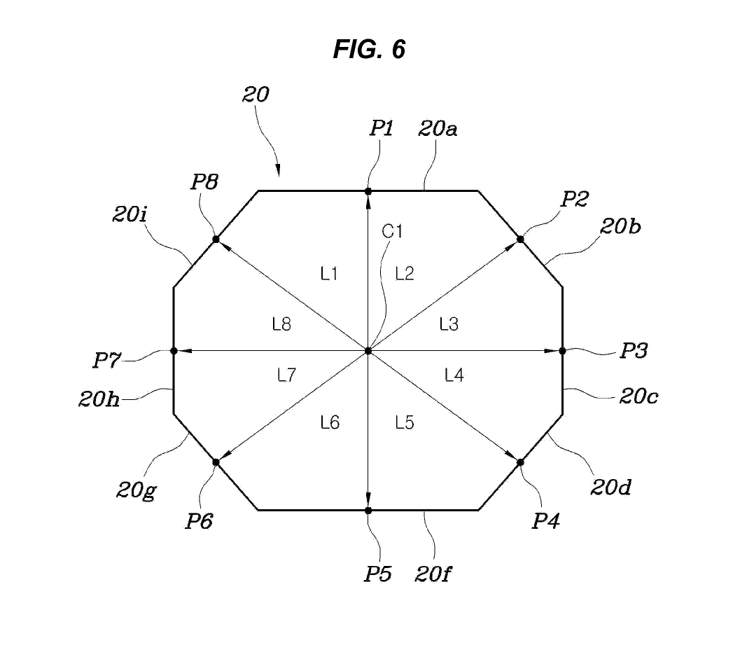

An acceleration pedal of a vehicle includes, as shown in FIGS. 2 to 6, a pedal arm housing 1 fixed to the dash panel under a driver seat, a pedal arm 2 having an end equipped with a pedal 2a and the other end inserted in the pedal arm 1 to be rotatable about a hinge shaft 2b with respect to the pedal arm housing 1, a spring plate 3 coupled to the end of the pedal arm 2 disposed in the pedal arm housing 1, a friction shoe 4 coupled to the pedal arm 2 disposed in the pedal arm housing 1 and generate frictional interference with the inner wall of the pedal arm housing 1 when the pedal arm 2 rotates, and an elastic member 5 having one end supported by the spring plate 3 and the other end supported by the inner side, opposite the spring plate 3, of the pedal arm housing 1, in which the elastic member 5 is composed of an inner spring 5a and an outer spring 5b.

According to the acceleration pedal device, the sum of the reaction force of the friction shoe 4 generating frictional interference with the inner wall of the pedal arm housing 1 and the reaction force generated by the inner spring 5a and the outer spring 5b elastically compressed, when the pedal arm 2 pivots about a hinge shaft 2b, is a pedal effort that is applied to the pedal arm 2.

The prevent invention provides a configuration that allows a user to easily change pedal effort characteristics without changing the reaction force of the friction shoe 4 and replacing the elastic member in the acceleration pedal device having the configuration described above.

That is, a pedal effort adjusting apparatus of an acceleration pedal according to the present invention includes a rotary cam 20 that is disposed in a carrier housing 10 and has one end supported to be rotatable about the axis of the carrier housing 10, and a carrier 30 that is disposed in the carrier housing 10, with the upper surface being in contact with the outer circumference of the rotary cam 20 and the lower surface being in contact with one end of the elastic member 5 providing a pedal effort to the pedal arm 2, and presses the elastic member 5 or move to release the elastic member 5 when the rotary cam 20 rotates.

The carrier housing 10 may integrally and/or monolithically formed with the pedal arm housing 1 opposite the end of the pedal arm 2 in the rotational direction of the pedal arm 2.

The pedal arm 1 is separably assembled with the pedal arm housing cover 6, a carrier housing cover 7 may be integrally and/or monolithically formed with the pedal arm housing cover 6, and the carrier housing cover 7 is separably assembled simultaneously when the pedal arm housing cover 6 is assembled with the pedal arm housing 1.

Further, a camshaft 1 integrally protrudes from one side of the rotary cam 20 and can rotate about the axis through a shaft hole 11 formed at the carrier housing 10.

That is, a camshaft groove 21a is integrally formed inward circumferentially along the outer circumference of the camshaft 21 and the edge of the shaft hole 11 is fitted in the camshaft groove 21a, such that the camshaft 21 can rotate about the axis along the edge of the shaft hole 11.

Meanwhile, the rotary cam 20 has a polygonal cross-section with a plurality of planes 20a to 20i and it is assumed that the points dividing the lengths of the planes 20a to 20i are middle positions P1 to P8, the lengths L1 to L8 of the straight lines connecting the middle positions P1 to P8 of the planes 20a to 20i to the rotational center C1 of the rotary cam 20 are set different.

The rotational center C1 of the rotary cam 20 agrees with the rotational center of the camshaft 21.

As described above, as the distances L1 to L8 of the lines connecting the rotational center C1 of the rotary cam 20 to the middle positions P1 to P8 of the planes 20a to 20i are set different, when the rotary cam 20 rotates about the axis, the distance from the rotational center C1 of the rotary cam 20 to the upper surface of the carrier 30 changes in accordance with the planes 20a to 20i of the rotary cam 20 which come in contact with the upper surface of the carrier 30, such that it is possible to adjust the movement distance of the carrier 30 and correspondingly adjust the elastic force of the elastic member 5, and accordingly, it is possible to adjust the pedal effort of the pedal arm 2.

Further, a tool insertion groove 22 is formed on one side of the camshaft 21 which protrudes outward from the carrier housing 10 through the shaft hole 11 and the apparatus according to the present invention further include a pedal effort adjusting tool 40 that is inserted in the tool insertion groove 22 to allow the rotary cam 20 to rotate about the axis.

The operation of the apparatus of the present invention is described hereafter.

When a driver rotates the pedal arm 2 by pressing down the pedal 2a without adjusting the pedal effort, the elastic member 5 is compressed and the carrier 30 keeps fixed by the rotary cam 20 even if the elastic force of the elastic member 5 is transmitted to the carrier 30, such that the acceleration pedal normally operates.

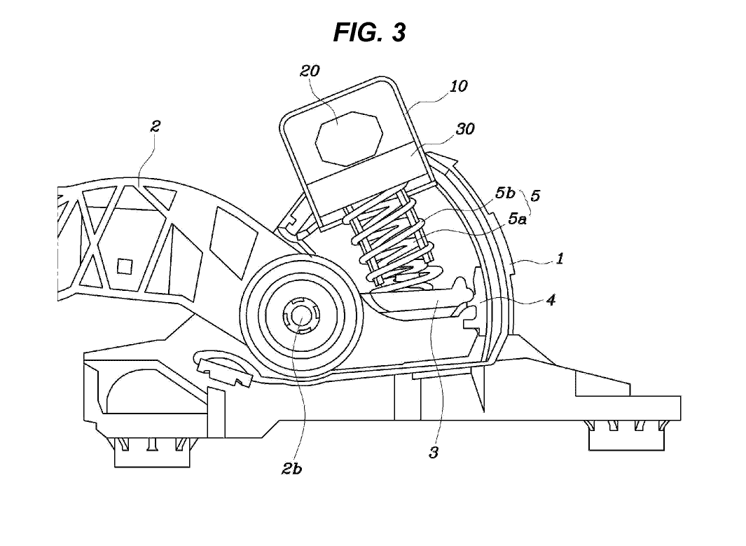

That is, since the camshaft 21 of the rotary cam 20 is fitted in the shaft hole 11 of the carrier housing 10, the rotary cam 20 cannot move toward the carrier 20 or in the opposite direction (the rotary cam cannot move upward and downward in FIG. 3), such that even if the elastic member 5 is compressed when the pedal arm 2 rotates and the elastic force of the elastic member 5 is transmitted to the carrier 30, the carrier 30 can keep fixed by the rotary cam 20, and accordingly, the acceleration pedal normally operates.

Further, when a worker inserts the end of the pedal effort adjusting tool 40 into the tool insertion groove 22 of the camshaft 21 and turns the tool clockwise and counterclockwise in order to adjust the pedal effort, any one of the planes 20a to 20i of the rotary cam 20 comes in contact with the upper surface of the carrier 30.

However, since all the planes 20a to 20i of the rotary cam 20 are formed at different distances from the rotational center C1 of the rotary cam 20 and the distance from the rotational center C1 of the rotary cam 20 to the upper surface of the carrier 30 changes in accordance with the planes 20a to 20i of the rotary cam 20 which come in contact with the upper surface of the carrier 30, as the rotary cam 20 rotates about the axis, the carrier 30 moves to compress the elastic member 5 or moves in the opposite direction to release the compressed elastic member 5.

When the carrier 30 moves to compress the elastic member 5 (the carrier moves down toward the spring plate in the state of FIG. 3), the elastic member 5 is compressed and deformed and the elastic force increases, such that the pedal effort of the pedal arm 2 gradually increases.

On the contrary, when the carrier 30 moves to release the compressed elastic member 5 (the carrier moves up toward the rotary cam in the state of FIG. 3), the compressed elastic member 5 elastically restores and the elastic force decreases, such that the pedal effort of the pedal arm 2 gradually decreases.

As described above, the pedal effort adjusting apparatus according to the present invention makes it possible to adjust the elastic force of the elastic member 5 by moving the carrier 30 with the rotation of the rotary cam 30 without replacing the friction shoe 4 and the elastic member 5, such that it is possible to adjust the pedal effort of the pedal arm 2.

Therefore, the apparatus according to the present invention has the advantages that it is possible to easily adjust the pedal effort of the pedal arm 2 of the acceleration pedal with a simple operation, if necessary, and particularly, it is possible to make the acceleration pedal compatible while sufficiently satisfying the law of safety about a pedal effort.

Although the present invention was described with reference to a specific embodiment, it is apparent to those skilled in the art that the present invention may be changed and modified in various ways without departing from the scope of the present invention which is provided in the following claims.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pedal effort adjusting apparatus of an acceleration pedal comprising:
a rotary cam that is disposed in a carrier housing and has one end supported to be rotatable about the axis of the carrier housing; and
a carrier that is disposed in the carrier housing, with the upper surface being in contact with an outer circumference of the rotary cam and a lower surface being in contact with one end of an elastic member providing a pedal effort to a pedal arm of the acceleration pedal, wherein the carrier selectively presses the elastic member or releases the elastic member as the rotary cam rotates.

2. The apparatus of claim 1, wherein the carrier housing is integrally formed with the pedal arm housing opposite an end of the pedal arm in the rotational direction of the pedal arm.

3. The apparatus of claim 1, wherein a camshaft integrally protrudes from one side of the rotary cam, and the camshaft rotates about an axis through a shaft hole formed in the carrier housing.

4. The apparatus of claim 1, wherein the rotary cam has an outer circumference with a polygonal cross-section including of a plurality of continuous circumferential planes.

5. The apparatus of claim 3, wherein a camshaft groove is integrally and circumferentially recessed along an outer circumference of the camshaft, and an edge of the shaft hole is fitted in the camshaft groove.

6. The apparatus of claim 4, wherein when midpoints dividing lengths of circumferential planes into two parts, respectively, are middle positions P1 to P8, the distances L1 to L8 of the straight lines connecting the middle positions P1 to P8 of the respective circumferential planes to a rotational center C1 of the rotary cam are set different.

7. The apparatus of claim 3, wherein a tool insertion groove is formed on one side of the cam shaft which protrudes outward from the carrier housing through the shaft hole, and the apparatus further comprises a pedal effort adjusting tool that is inserted in the tool insertion groove to allow the rotary cam to rotate about the axis.
